(19) United States
(12) Patent Application Publication
(10) Pub. No.: US 2004/0120329 A1
(43) Pub. Date: Jun. 24, 2004

(54) SNMP management with a layer 2 bridge device

(76) Inventors: Wen-Tzu Chung, Hsinchu (TW); Kun-Hsiao Li, Hsinchu (TW); Chun-Te Wu, Hsinchu (TW)

Correspondence Address: SUPREME PATENT SERVICES, POST OFFICE BOX 2339, SARATOGA, CA, 95070, US

(21) Appl. No.: 10/324,350

(22) Filed: Dec. 18, 2002

(51) Int. Cl. H04L 12/56

(52) U.S. Cl. 370/407

(57) ABSTRACT

A method of managing layer 2 devices uses SNMP protocol with an Ethernet connection without an USB or RS-232 port. When a gateway is setup to communicate with a client PC, an Ethernet packet with a pre-configured static IP address is sent out for the layer 2 device to read, intercept and process the payload in the IP packet of the Ethernet packet. If the gateway does not exist or is not set up properly for communication, a multicast frame to the address of 224.0.23.1 is sent out. The layer 2device recognizes the multicast address and process the protocol.

### FIELD OF THE INVENTION

The present invention generally relates to the management of a layer 2 bridge device, and more specifically to a method of managing a layer 2 bridge device using an existing Ethernet port without an additional communication port.

### BACKGROUND OF THE INVENTION

SNMP was defined and established as a standard for simple network management. The SNMP protocol can be applied to any layer 3 network device with an IP address that supports SNMP management. Under normal circumstances, a layer 2 device does not have an IP address, which means that it can not be managed via SNMP.

There is very little need in managing a layer 2 bridge device. For example, configuration of the device happens rarely during the life time of the device and in many cases, it may be used only once during the initial startup. However, this rare need still has to be satisfied. The conventional approach to managing a layer 2 bridge device is to use either an RS232 communication port or a USB port to establish communication with the device so as to allow configuration. Because of the rare use, the addition of a USB or RS232 port becomes costly and wasteful.

### SUMMARY OF THE INVENTION

This invention has been made to overcome the above mentioned drawback of using an additional port to manage a layer 2 bridge device. The primary object of this invention is to provide a method of using an existing Ethernet port to manage the layer 2 bridge device without extra hardware and to streamline the configuration process so that it is both effective and cost-efficient.

Another object is to provide SNMP management for the configuration of the layer 2 bridge device. Accordingly, the SNMP management of the layer 2 bridge device has two possible configurations dependent on whether a gateway device can respond to the network communication or not. A proprietary protocol prepares and sends out an IP packet that uses a pre-configured static IP address as the destination IP address if the client PC can communicate with the gateway via the layer 2 bridge device. The layer 2 device will intercept and process the packet payload pretending itself as the gateway. With an established connection, the SNMP protocol can be applied between the client and the layer 2 device via the process of request and response defined by SNMP. If the network configuration is not set up properly or a gateway device does not exist, then a multicast frame to the address of 224.0.23.1 will be sent out. When the packet is read by the layer 2 device, it will recognize the multicast address defined in the protocol and process the packet.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a PC client connects to a gateway through a layer 2 bridge device.

FIG. 2 shows the detailed steps of SNMP management for the layer 2 bridge device using Ethernet connection without an additional USB or RS-232 port.

FIG. 3 illustrates how the SNMP management of the layer 2 device works when the gateway can respond to the ARP request.

FIG. 4 illustrates how the SNMP management of the layer 2 device works when the gateway does not respond to the ARP request

### DETAILED DESCRIPTION OF THE PREFERRED EMBODIMENTS

This invention applies the,SNMP protocol, which is strictly a layer 3 protocol, to a layer 2 device such as a bridge. The bridge is equipped with a pre-configured static IP address and an SNMP agent, either of which can only be addressed from within the client side of the bridge. The IP address inside the layer 2 bridge can not be addressed from the other side of the bridge (gateway side). At the network side, the layer 2 bridge is still treated as a none IP device under normal operation.

When the bridge or the layer 2 device is not in a configuration mode, it is also transparent from the client side. Under the configuration mode, a PC running SNMP at the client side can apply SNMP to manage the bridge. There are several advantages of this kind of management as compared to the conventional approaches. One is the elimination of an additional RS232 port or USB port which is costly and inefficient due to the lack of usage but required for configuration. Another advantage is that it provides a simple and cost efficient way of managing layer 2 devices. It also has the advantage that existing and proven software already developed for SNMP management can be implemented without having to create a new protocol.

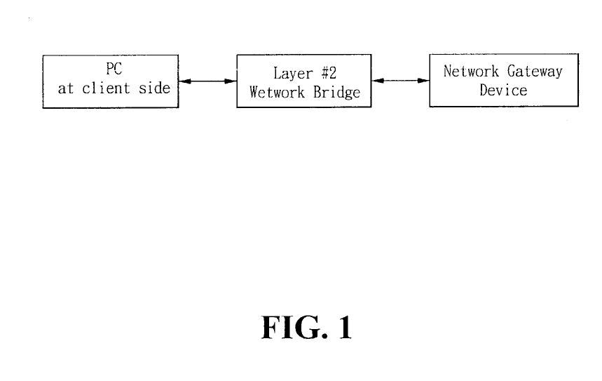

As shown in FIG. 1, a layer 2 network bridge is connected between a PC at a client side and a network gateway device. The connection of the layer 2 network bridge to the gateway may be an IEEE 802.3 Ethernet cable or an IEEE 802.11 wireless connection through radio signals. The SNMP management of the layer 2 network bridge according to this invention has two possible configurations. In one configuration, a client PC can communicate with a gateway through the layer 2 device and in the other configuration, the client PC can not communicate with the gateway. Using a pre-configured static IP that can only be seen from the client side, the layer 2 device will intercept an Ethernet Packet sent by the client PC and read the destination IP address in the IP Packet if the client PC can communicate with a gate way. This happens to any packet that enters the layer 2 device from a client port. If the IP address encapsulated inside the Ethernet Packet matches the layer 2 bridge device's IP address, then the packet will not be forwarded. Instead, the layer 2 device will intercept and process the packet payload pretending itself as the gateway. Now with an established connection, the SNMP protocol can be applied between the client and the layer 2 device via the process of request and response defined by SNMP.

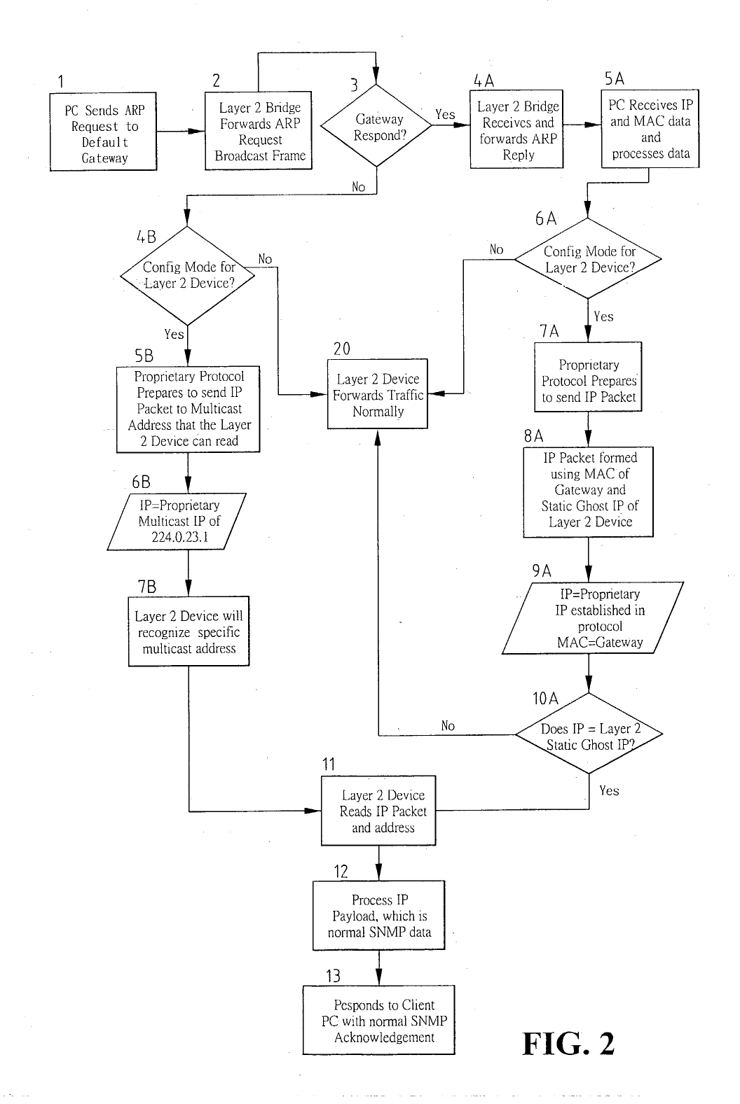

If the network configuration is not set up properly or the gateway does not exist, then a multicast frame to the address of 224.0.23.1 will be sent out. When the packet is read by the layer 2 device, it will recognize the multicast address defined in the protocol and process the packet. This is accomplished while keeping the layer 2 bridge transparent to both the outside world as well as the user during normal operation. A detailed explanation of what occurs during the process of SNMP management with a layer 2 device is described below by referring to the processing steps shown in FIG. 2.

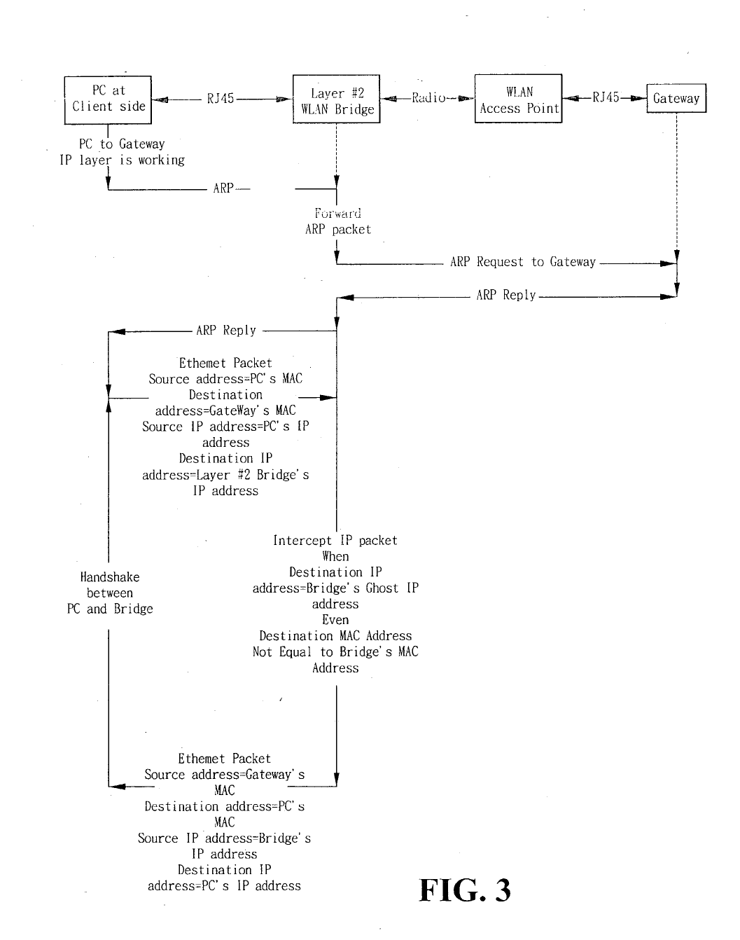

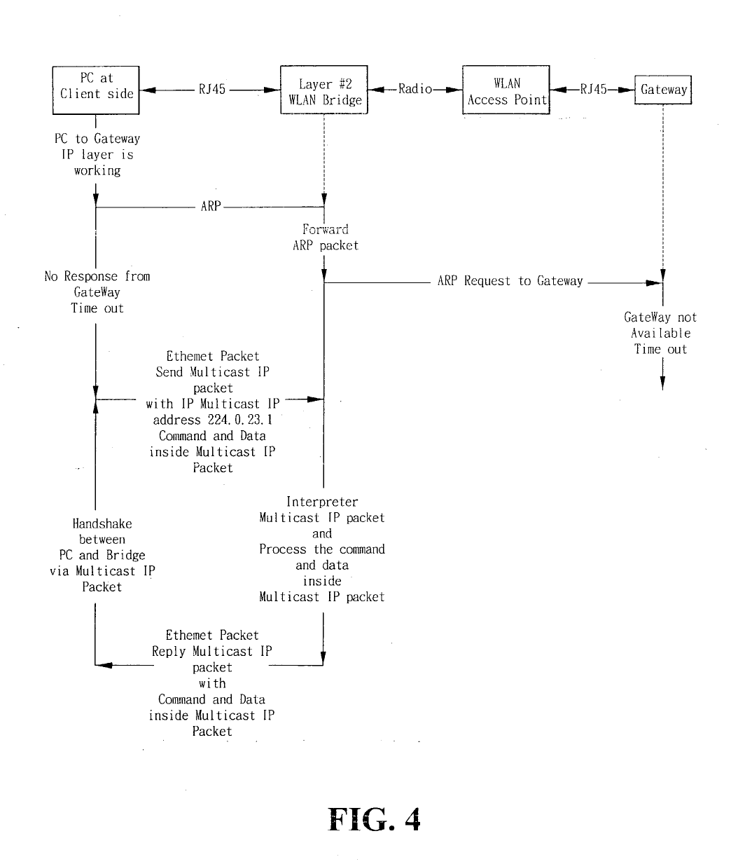

With reference to FIG. 2, during the initialization the client automatically sends address resolution protocol (ARP) request to the default gateway to determine MAC address (step 1). When the ARP packet arrives at the layer 2 bridge. the bridge forwards the packet following a normal operating procedure (step 2). According to how the gateway device responds to the forwarded ARP request, the SNMP management of this invention decides what the following actions should be (step 3). If the gateway device does respond, the SNMP protocol will select one decision path to establish a connection with the layer 2 bridge. If it does not respond, then a different decision path will be selected. FIGS. 3 and 4 show the actions taken by the two decision paths respectively.

If the ARP broadcast is received by the gateway and a reply is returned with a MAC address of the gateway, the ARP reply is forwarded to the client PC by the layer 2 bridge (step 4A). The client PC receives data from the ARP reply and processes the MAC address (step 5A). The bridge device may or may not be in a configuration mode (Step 6A). If it is not in the configuration mode, normal operation continues to forward network traffic. If it is in the configuration mode, the proprietary protocol of this invention issues an IP packet out to a statically configured IP address that the layer 2 device will recognize (step 7A). FIG. 3 illustrates how the SNMP management of the layer 2 device works when the gateway can respond to the ARP request,

After it is determined that an IP packet should be sent out for the configuration mode, the Ethernet packet is formed with the MAC address of the gateway learned in the ARP transaction and the statically configured ghost IP address, which is the layer 2 bridge's IP address (step 8A). As shown in FIG. 3, the source address of the Ethernet packet is the MAC address of the client PC and the destination address is the MAC address of the gateway. The source IP address is the IP address of the PC and the destination IP address is the pre-configured static ghost IP address of the layer 2 bridge device. The IP packet is then sent out by the proprietary protocol of the invention (step 9A). Once the IP Packet hits the layer 2 bridge, the Ethernet layer is stripped away and the IP destination of the IP Packet is read and checked (step 10A). if it is not equal to the ghost IP address configured within the proprietary protocol, it will be passed on and normal operation will continue to forward network traffic (step 20).

On the other hand, if the destination IP address is equal to the ghost IP address of the bridge, the IP packet is intercepted and the IP payload which contains normal SNMP data is read and processed (steps 11 and 12). It should be noted that the IP packet is intercepted even if the destination MAC address is not the MAC address of the bridge device. The bridge then responds to the client PC with a normal SNMP acknowledgement (step 13). As shown in FIG. 3, the acknowledged Ethernet packet has a source address equal to the MAC address of the gateway and a destination address equal to the MAC address of the PC. The source IP address is the IP address of the bridge and the destination IP address is the IP address of the PC. Handshaking between the PC and the bridge is thus maintained via the ghost IP address of the layer 2 bridge device.

As shown in FIG. 2, if the gateway does not respond, the SNMP management of this invention determines if the layer 2 device is in configuration mode or not (step 4B). If it is not, then normal operation continues to forward network traffic (step 20). If the layer 2 bridge device is in the configuration mode, the proprietary protocol of this invention will prepare a multicast IP packet to be sent out and received by the layer 2 device (step 5B). FIG. 4 illustrates how the SNMP management of the layer 2 device works when the gateway does not respond to the ARP request. The Ethernet packet is a multicast IP packet sent out to a multicast IP address 224.0.23.1, which is specific to the proprietary protocol for the layer 2 device to receive (step 6B). Command and data are also contained inside the multicast IP packet. The layer 2 device recognizes that the address is a multicast address and matches it's configuration address (step 7B). As shown in FIG. 4, the layer 2 device interprets the multicast IP packet and process the command and data inside the multicast IP packet. The layer 2 bridge responds to the PC with a multicast IP packet which contains command and data. Consequently, handshaking between the PC and the bridge is maintained via a multicast IP packet.

After step 7B or step 10A, the action of the proprietary protocol is the same regardless of the earlier response of the gateway. When layer 2 device recognizes that the IP packet is destined for itself, it opens and reads the IP payload, which can be SNMP configuration or any other IP based management protocol (step 11). The payload is then processed and the configuration of the layer 2 device commences (step 12). The layer 2 device proceeds with normal SNMP transactions. It then proceeds with normal operation once the configuration mode comes to an end (step 13).

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as-defined in the appended claims.

What is claimed is:

1. A method of managing a layer 2 device using SNMP protocol, comprising the steps of:
(a) sending an ARP request from a PC through said layer 2 device to a default gateway;
(b) executing a layer 2 device SNMP management procedure via an Ethernet packet having a multicast IP address if said default gateway fails to respond or does not exist; and
(c) executing a layer 2 device SNMP management procedure via an Ethernet packet having a pre-configured IP address if said default gateway responds with an ARP reply.

2. The method of managing a layer 2 device using SNMP protocol, wherein said step (b) comprises the steps of:
(b1) sending a multicast IP packet from said PC to said layer 2 device, said multicast IP packet having a pre-determined multicast IP address;
(b2) receiving and interpreting said multicast IP packet in said layer 2 device, and processing commands and data of said multicast IP packet;
(b3) replying to said PC from said layer 2 device with a multicast IP packet; and
(b4) maintaining handshaking between said PC and said layer 2 device via a multicast IP packet.

3. The method of managing a layer 2 device using SNMP protocol, wherein said step (c) comprises the steps of:
(c1) forwarding said ARP reply from said layer 2 device to said PC;
(c2) receiving said ARP reply in said PC and obtaining a MAC address of said default gateway from said ARP reply;
(c3) sending an Ethernet packet from said PC to said layer 2 device, said Ethernet packet having a MAC address of said PC as a source address, said MAC address of said gateway as a destination address, an IP address of said PC as a source IP address, said pre-configured IP address of said layer 2 device as a destination IP address, and an IP payload;
(c4) receiving said Ethernet packet in said layer 2 device;
(c5) processing said IP payload by intercepting an IP packet of said Ethernet packet when said Ethernet packet has said pre-configured IP address as a destination IP address;
(c6) replying to said PC from said layer 2 device with an Ethernet packet having said MAC address of said gateway as a source address, said MAC address of said PC as a destination address, said pre-configured IP address of said layer 2 device as a source IP address, said IP address of said PC as a destination IP address;
(c7) maintaining handshaking between said PC and said layer 2 device via an Ethernet packet having said pre-configured IP address.
